(19) United States
(12) Patent Application Publication
(10) Pub. No.: US 2007/0191074 A1
(43) Pub. Date: Aug. 16, 2007

(54) Power transmission network and method

(75) Inventors: Daniel W. Harrist, Carnegie, PA (US); Charles E. Greene, Cabot, PA (US); John G. Shearer, Ligonier, PA (US)

Correspondence Address: Ansel M. Schwartz;Attorney at Law, Suite 304, 201 N. Craig Street, Pittsburgh, PA, 15213, US

(73) Assignee: Powercast, LLC

(21) Appl. No.: 11/699,148

(22) Filed: Jan. 29, 2007

Related U.S. Application Data
(63) Continuation-in-part of application No. 11/438,508, filed on May 22, 2006.
(60) Provisional application No. 60/683,991, filed on May 24, 2005.
(60) Provisional application No. 60/763,582, filed on Jan. 31, 2006.

(51) Int. Cl. H04B 1/10; H04B 1/38; H04M 1/00

(52) U.S. Cl. 455/572; 455/299

(57) ABSTRACT

A network for power transmission to a receiver which converts the power into current includes a first node for transmitting power with circularly polarized waves in a first area. The network includes a second node for transmitting power with circularly polarized waves in a second area. Alternatively, elliptically polarized waves or dual polarized waves are used or different frequencies are used or different polarizations are used or different polarization vectors are used. Also disclosed is a method for power transmission to a receiver which converts the power into current.

### BACKGROUND OF THE INVENTION

1. Field of the Invention

The present invention relates to power transmission to a receiver which converts the power into current. More specifically, the present invention relates to power transmission to a receiver which converts the power into current using circularly polarized waves, or elliptically polarized waves or dual polarized waves or different frequencies or different polarizations or different polarization vectors.

2. Description of Related Art

Power Transmission networks are around us every day. The most common is the Alternating Current (AC) power network within our homes and office buildings. The utility companies use this wired network to supply AC power to us. This network is capable of supplying large amounts of power to a device directly connected to it.

The key to the operation of this network is the direct connection. It is not always possible or practical to hardwire or plug-in every device. An example of this can be seen by examining the building automation market.

There is currently a drive to conserve energy in office buildings and homes. This is done by optimizing how the power is used. As an example, there is no need to light a room when it is not occupied. This problem has been addressed and is solved by placing a motion sensor in the room. When there is no motion for a given period of time, the lights are turned off.

The problem with this solution is that each motion sensor requires power. This means that each sensor is hardwired to the AC power network or must contain a battery. This may not be practical in all applications. Each sensor must also have a way to control the operation of the lights in the room.

The current trend is to implement wireless sensors. However, the term “wireless” in this case refers only to the communication portion of the device. The power for the device must still be derived from the traditional sources such as the AC power network or batteries.

### BRIEF SUMMARY OF THE INVENTION

The present invention eliminates the need for a hardwired connection for each sensor. The power for the device is derived from a wireless power network. This power can be used to directly power the device or to recharge or augment an internal battery. With the present invention, the device becomes wireless in both a communication and powering sense. The specifics of the invention are explained in detail in the following document.

The present invention pertains to a network for power transmission to a receiver which converts the power into current. The network comprises a first node for transmitting power with circularly polarized waves in a first area. The network comprises a second node for transmitting power with circularly polarized waves in a second area.

The present invention pertains to a network for power transmission to a receiver having an RF receiving antenna with a polarization which converts the power into current. The network comprises a first node for transmitting power with elliptically polarized waves in the first area. The network comprises a second node for transmitting power elliptically polarized waves in a second area.

The present invention pertains to a method for power transmission to a receiver which converts the power into current. The method comprises the steps of transmitting power with circularly polarized waves from a first node in a first area. There is the step of transmitting power with circularly polarized waves from a second node in a second area.

The present invention pertains to a method for power transmission to a receiver having an RF receiving antenna with a polarization which converts the power into current. The method comprises the steps of transmitting power with elliptically polarized waves from a first node in a first area. There is the step of transmitting power with elliptically polarized waves from a second node in a second area.

The present invention pertains to a network for power transmission to a receiver which converts the power into current. The network comprises a first node for transmitting power with dual polarized waves in a first area. The network comprises a second node for transmitting power with dual polarized waves in a second area.

The present invention pertains to a method for power transmission to a receiver which converts the power into current. The method comprises the steps of transmitting power with dual polarized waves from a first node in a first area. There is the step of transmitting power with dual polarized waves from a second node in a second area.

The present invention pertains to a network for power transmission to a receiver which converts the power into current. The network comprises a first node having components for transmitting power at a first frequency in a first area. The network comprises a second node having components for transmitting power at a second frequency in a second area. The second frequency is different than the first frequency due to tolerances in the components of the first and second nodes.

The present invention pertains to a method for power transmission to a receiver which converts the power into current. The method comprises the steps of transmitting power with components at a first frequency of a first node in a first area. There is the step of transmitting power with components at a second frequency of a second node in a second area. The second frequency is different than the first frequency due to tolerances in the components of the first and second nodes.

The present invention pertains to a network for power transmission to a receiver which converts the power into current. The network comprises a first node for transmitting power on a first polarization in a first area. The network comprises a second node for transmitting power on a second polarization in a second area.

The present invention pertains to a network for power transmission to a receiver which converts the power into current. The network comprises a first node for transmitting power having first polarization vectors in a first area. The network comprises a second node for transmitting power having second polarization vectors in a second area.

The present invention pertains to a network for power transmission to a receiver which converts a power into current. The network comprises a plurality of transmitters which together use a first total transmitted power and yield a power coverage area equivalent to a single power transmitter power coverage area which uses a second total transmitted power, where the first total transmitted power is less than the second total transmitted power.

The present invention pertains to a method for power transmission to a receiver which converts the power into current. The method comprises the steps of yielding a power coverage area with a plurality of transmitters which together use a first total transmitted power equivalent to a single power transmitter power coverage area which uses a second total transmitted power, where the first total transmitted power is less than the second total transmitted power. There is the step of receiving power by the receiver in the power coverage area from at least one of the plurality of transmitters.

The present invention pertains to a system for power transmission. The system comprises a receiver including a receiver antenna. The system comprises an RF power transmitter including a transmitter antenna. The RF power transmitter transmits RF power. The RF power includes multiple polarization components, and the receiver converts the RF power to DC.

The present invention pertains to a security system to sense intruders. The security system comprises a plurality of sensors to sense the intruders disposed about a parameter, each sensor has an RF wireless receiver to receive RF wireless energy and convert it into current to power the sensor. The security system comprises a plurality of transmitters to provide wireless RF energy to the receivers.

The present invention pertains to a method for power transmission. The method comprises the steps of transmitting RF power wirelessly having multiple polarization components with an RF power transmitter having a transmitter antenna. There is the step of receiving the wireless RF power at a receiver having a receiver antenna. There is the step of converting the RF power to DC by the receiver.

### BRIEF DESCRIPTION OF THE SEVERAL VIEWS OF THE DRAWINGS

FIG. 1 shows a power network with multiple coverage areas, where one receiver is in each coverage area.

FIG. 2 shows the power network shown in FIG. 1, where more than one receiver is in each coverage area.

FIG. 3 shows a power network that combines multiple coverage areas to provide a greater coverage area.

FIG. 4 shows a dead spot within a coverage area.

FIG. 5 shows a power network implemented with a controller.

FIG. 6A shows two block diagrams of possible controllers.

FIG. 6B shows a circularly polarized antenna vector.

FIG. 7 shows an elliptically polarized antenna vector.

FIG. 8 shows a power network with a source with multiple antennas used to create multiple coverage areas.

FIG. 9 shows a power network with a controller and a source with multiple antennas used to create multiple coverage areas.

FIG. 10 shows a room for implementing a power network.

FIG. 11 shows a patch antenna coverage area for the room shown in FIG. 9.

FIG. 12 shows coverage of the room shown in FIG. 9 with a single patch antenna in one of the corners.

FIG. 13 shows a power network within the room shown in FIG. 9.

FIG. 14 shows a power network with multiple transmitters, multiple controllers, and multiple antennas used to create multiple coverage areas.

FIG. 15 shows coverage for a twenty-watt transmitter located at a center of a 36′ by 30′ room.

FIG. 16 shows coverage for four five-watt transmitters located in the room of FIG. 15.

FIG. 17 shows coverage for four two and one-half-watt transmitters to provide an equivalent power coverage as a single twenty-watt transmitter.

FIG. 18 shows a transmitter antenna that has more than one antenna.

FIG. 19 shows a security system.

FIG. 20 shows a controller with one MCU or CPU and memory.

FIG. 21 shows a transmitter in a sensor.

FIG. 22 shows a receiver directly powering a device.

### DETAILED DESCRIPTION OF THE INVENTION

A complete understanding of the invention will be obtained from the following description when taken in connection with the accompanying drawing figures wherein like reference characters identify like parts throughout.

For purposes of the description hereinafter, the terms “upper”, “lower”, “right”, “left”, “vertical”, “horizontal”, “top”, “bottom”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

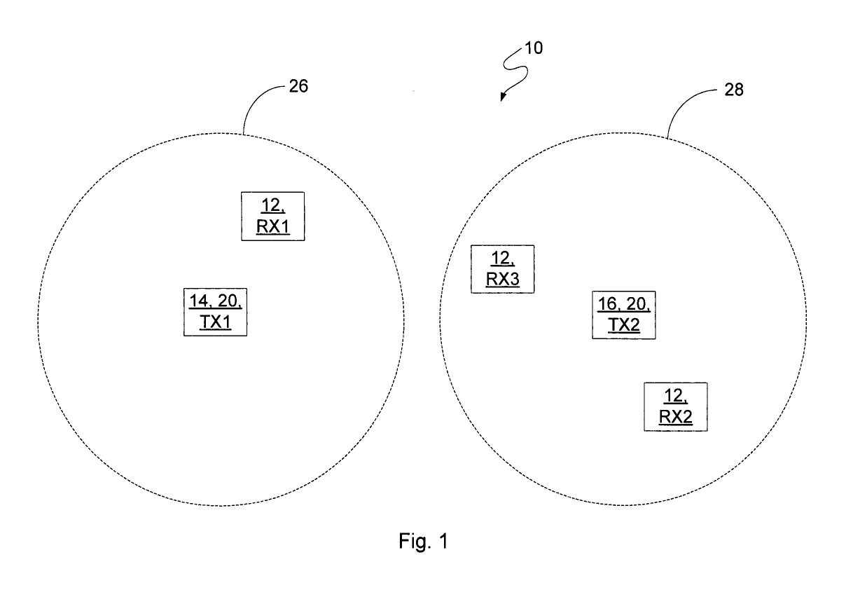

The present invention pertains to a network 10 for power transmission to a receiver 12 which converts the power into current, as shown in FIG. 1. The network 10 comprises a first node 14 for transmitting power with circularly polarized waves in a first area 26. The network 10 comprises a second node 16 for transmitting power with circularly polarized waves in a second area 28.

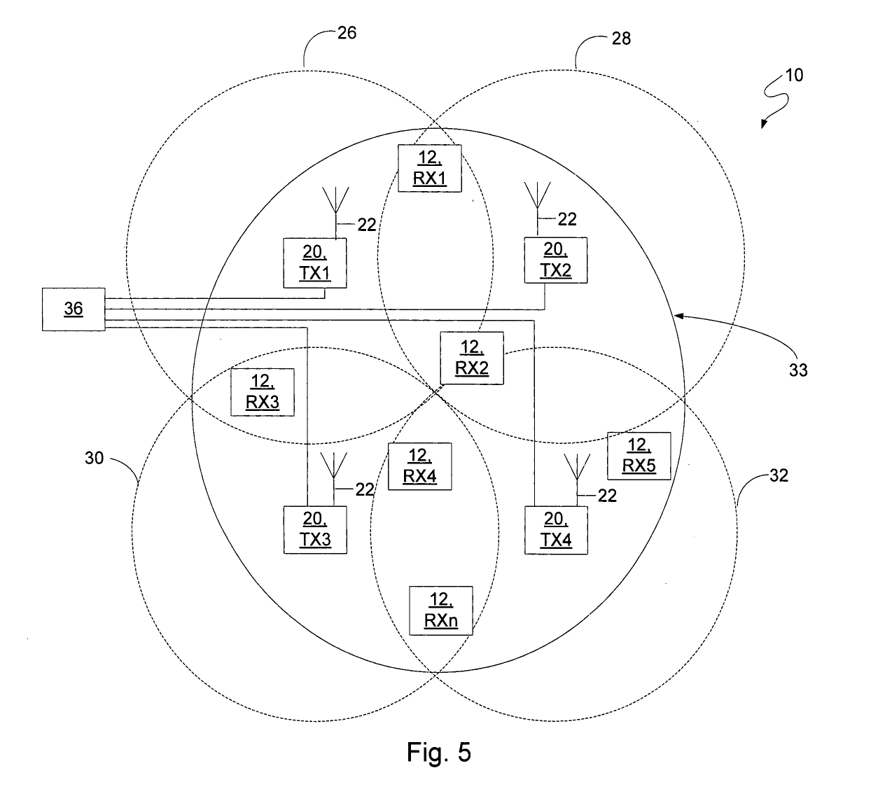

A node is a point of energy emanation, preferably of RF waves. A node may include an antenna 22 in communication with a transmitter 20 outside of the coverage area (possibly in another coverage area); an antenna 22 in communication with a transmitter 20 inside the coverage area; or a unit containing an antenna 22 and a transmitter 20. A node may also include a controller 36, as shown in FIG. 5.

The present invention pertains to a network 10 for power transmission to a receiver 12 having an RF receiving antenna 22 with a polarization which converts the power into current. The network 10 comprises a first node 14 for transmitting power with elliptically polarized waves in the first area 26.

The network 10 comprises a second node 16 for transmitting power elliptically polarized waves in a second area 28.

Preferably, the polarized waves have polarization vectors with an axial ratio set by a probability of the polarization of the RF receiving antenna 22.

The present invention pertains to a method for power transmission to a receiver 12 which converts the power into current. The method comprises the steps of transmitting power with circularly polarized waves from a first node 14 in a first area 26. There is the step of transmitting power with circularly polarized waves from a second node 16 in a second area 28.

The present invention pertains to a method for power transmission to a receiver 12 having an RF receiving antenna 22 with a polarization which converts the power into current. The method comprises the steps of transmitting power with elliptically polarized waves from a first node 14 in a first area 26. There is the step of transmitting power with elliptically polarized waves from a second node 16 in a second area 28.

Preferably, the polarized waves have polarization vectors with an axial ratio set by a probability of the polarization of the RF receiving antenna 22.

The present invention pertains to a network 10 for power transmission to a receiver 12 which converts the power into current. The network 10 comprises a first node 14 for transmitting power with dual polarized waves in a first area 26. The network 10 comprises a second node 16 for transmitting power with dual polarized waves in a second area 28.

The present invention pertains to a method for power transmission to a receiver 12 which converts the power into current. The method comprises the steps of transmitting power with dual polarized waves from a first node 14 in a first area 26. There is the step of transmitting power with dual polarized waves from a second node 16 in a second area 28.

The present invention pertains to a network 10 for power transmission to a receiver 12 which converts the power into current. The network 10 comprises a first node 14 having components for transmitting power at a first frequency in a first area 26. The network 10 comprises a second node 16 having components for transmitting power at a second frequency in a second area 28. The second frequency is different than the first frequency due to tolerances in the components of the first and second nodes 14, 16.

The present invention pertains to a method for power transmission to a receiver 12 which converts the power into current. The method comprises the steps of transmitting power with components at a first frequency of a first node 14 in a first area 26. There is the step of transmitting power with components at a second frequency of a second node 16 in a second area 28. The second frequency is different than the first frequency due to tolerances in the components of the first and second nodes 14, 16.

The present invention pertains to a network 10 for power transmission to a receiver 12 which converts the power into current. The network 10 comprises a first node 14 for transmitting power on a first polarization in a first area 26. The network 10 comprises a second node 16 for transmitting power on a second polarization in a second area 28.

The present invention pertains to a network 10 for power transmission to a receiver 12 which converts the power into current. The network 10 comprises a first node 14 for transmitting power having first polarization vectors in a first area 26. The network 10 comprises a second node 16 for transmitting power having second polarization vectors in a second area 28.

The present invention pertains to a network 10 for power transmission to a receiver 12 which converts a power into current. The network 10 comprises a plurality of transmitters 20 which together use a first total transmitted power and yield a power coverage area equivalent to a single power transmitter 20 power coverage area which uses a second total transmitted power, where the first total transmitted power is less than the second total transmitted power.

The present invention pertains to a method for power transmission to a receiver 12 which converts the power into current. The method comprises the steps of yielding a power coverage area with a plurality of transmitters 20 which together use a first total transmitted power equivalent to a single power transmitter 20 power coverage area which uses a second total transmitted power, where the first total transmitted power is less than the second total transmitted power. There is the step of receiving power by the receiver 12 in the power coverage area from at least one of the plurality of transmitters 20.

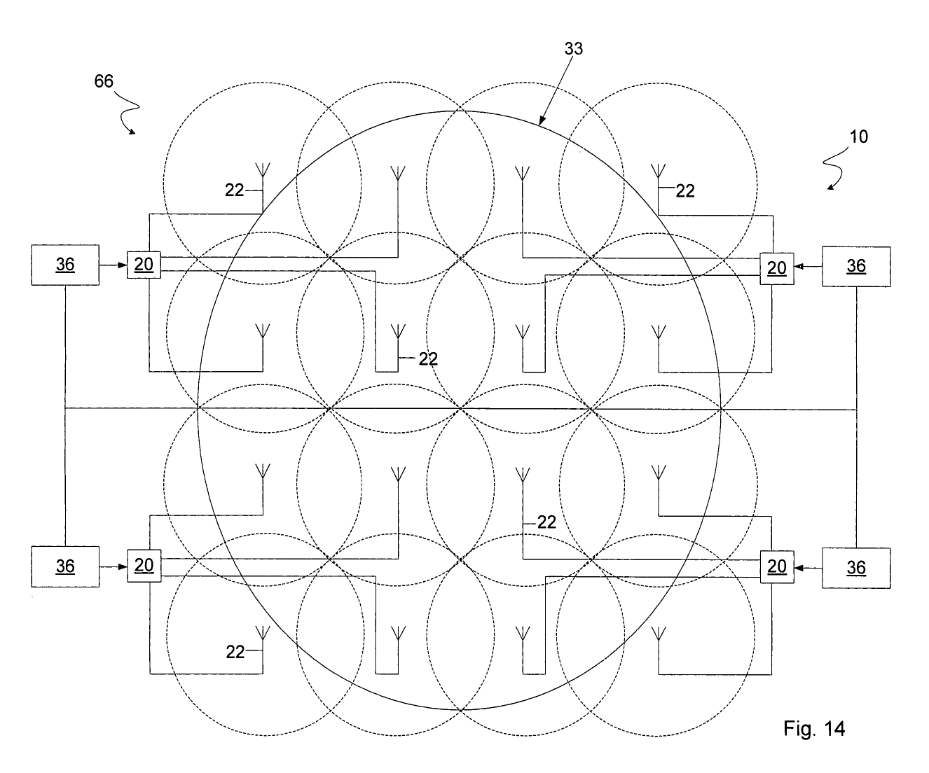

The present invention pertains to a system 66 for power transmission, as shown in FIG. 14. The system 66 comprises a receiver 12 including a receiver 12 antenna 22. The system 66 comprises an RF power transmitter 20 including a transmitter 20 antenna 22. The RF power transmitter 20 transmits RF power. The RF power includes multiple polarization components, and the receiver 12 converts the RF power to DC.

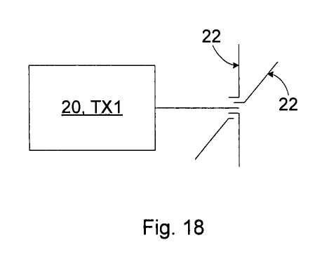

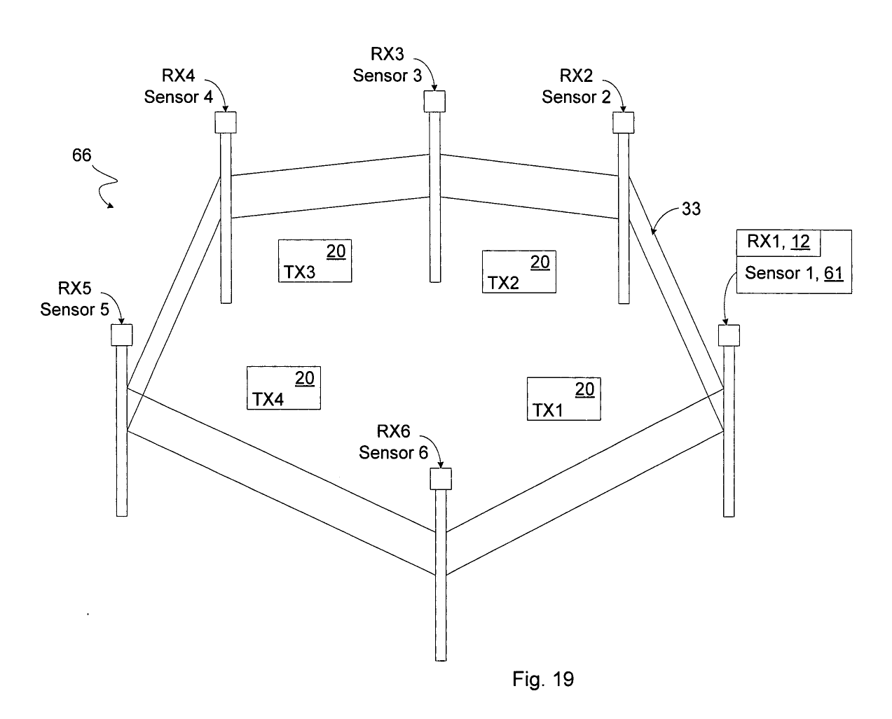

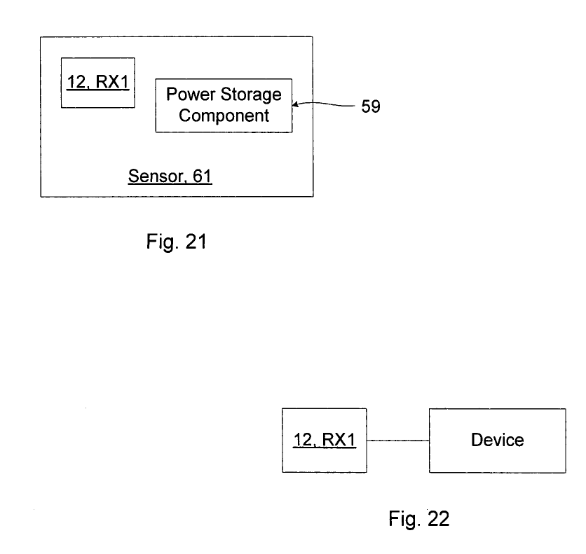

The RF power may or may not include data. The RF power transmitter 20 can pulse the transmission of the RF power. The transmitter 20 antenna 22 can include more than one antenna 22 as shown in FIG. 18. The receiver 12 can be included in a sensor 61, as shown in FIG. 21. The RF power can be used to charge at least one power storage component 59. The system 66 can include more than one receiver 12. The RF power can be used to directly power a device, as shown in FIG. 19.

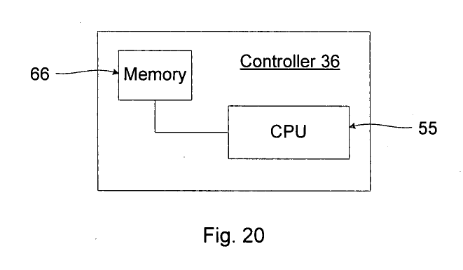

The system 66 can include a controller 36 connected to the transmitter 20 to switch the polarization of the antenna 22, as shown in FIG. 20. The controller 36 can include a CPU 55 or MCU and a memory 40. The system 66 can include a plurality of controllers 36 and a plurality of transmitters 20 with one of the plurality of controllers 36 associated with one of the plurality of transmitters 20, and the controllers 36 communicate with each other to coordinate the polarization of each transmitter 20 at a given time, as shown in FIG. 14. Each transmitter 20 can have an associated area in which it transmits and the controller 36 controls the polarization, frequency or shape of the area in which its associated transmitter 20 transmits.

The controllers 36 can be used to form a pulsing network 10 regarding transmission of the RF power. There can be a plurality of transmitters 20 with each transmitter 20 transmitting at a different frequency, where each transmitter 20 has the exact same components, values and design.

The present invention pertains to a security system 66 to sense intruders, as shown in FIG. 19. The security system 66 comprises a plurality of sensors 61 to sense the intruders disposed about a parameter, each sensor 61 has an RF wireless receiver 12 to receive RF wireless energy and convert it into current to power the sensor 61. The security system 66 comprises a plurality of transmitters 20 to provide wireless RF energy to the receivers 12.

The present invention pertains to a method for power transmission. The method comprises the steps of transmitting RF power wirelessly having multiple polarization components with an RF power transmitter 20 having a transmitter 20 antenna 22. There is the step of receiving the wireless RF power at a receiver 12 having a receiver 12 antenna 22. There is the step of converting the RF power to DC by the receiver 12.

Section 1

More specifically, in the operation of the invention, in order to supply power to stationary and mobile devices using Radio Frequency (RF) energy for the purpose of RF power harvesting or RF energy harvesting, it is necessary to establish an infrastructure similar to a cellular telephone network. The network 10 can take many different forms.

A simple form is a single transmitter 20 and a single receiver 12 in a given area. As FIG. 1 shows, a network 10 according to the present invention includes a first node 14 (implemented with a first Transmitter (TX1)) and a second node 16 (implemented with a second Transmitter (TX2)) to provide coverage over (power to) a first area 26 (Area 1) and a second area 28 (Area 2), respectively. It should be noted that although the term area is used and shown in the figures, a coverage area may be an area or a volume.

This allows TX1 to deliver power to a device in its coverage area such as a first receiver 12 RX1 for the purpose of directly powering the device or recharging a charge storage component. Likewise, TX2 can deliver power to a device in its coverage area such as a second receiver RX2 for the purpose of directly powering the device or recharging a charge storage component. The device to be powered may be the same device moving from the first area 26 to the second area 28, and vice versa. Additionally, more than one device may be powered by the network 10, for example, a device in each coverage area. Also, more than one device may be powered within each coverage area. For example, as shown in FIG. 1, a first device may include a first receiver RX1, a second device may include a second receiver RX2, and a third device may include a third receiver RX3. Receivers RX1, RX2, etc. include an antenna 22. The receivers 12 are designed to capture and convert the power into a useable form, such as, but not limited to, direct current (DC). Receivers 12, preferably, include an antenna 22 and a rectifier. U.S. patent application Ser. No. 11/584,983 entitled “Method and Apparatus for High Efficiency Rectification for Various Loads”, incorporated herein by reference, describes a receiver that may be used with the invention.

The coverage areas are defined by a minimum electric and/or magnetic field strength or minimum power density. As an example, Area 1 in FIG. 1 may be defined as the area that in which the electric field strength generated by Transmitter 1 (TX1) is greater than two volts per meter (2 V/m).

It should be noted that TX1 and TX2 in FIG. 1 contain an RF transmitter 20 and an antenna 22. Subsequent figures may use the same transmitter 20 block or may separate the transmitter 20 and antenna 22, specifically when the transmitter 20 is driving multiple antennas 22. When driving multiple antennas 22, the transmitter 20 may be referred to as a source or an RF power transmission source and may contain a switch, splitter, or other device for routing power 48.

Section 2

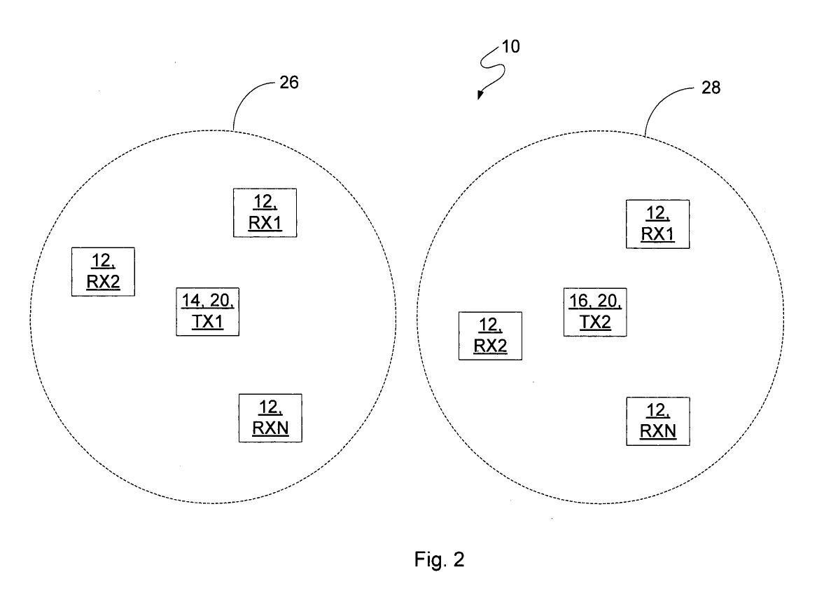

It is also possible for the network 10 to provide power to multiple devices within a single area. As in FIG. 2, Transmitter 1 (TX1) and Transmitter 2 (TX2) provide coverage over Area 1 and Area 2, respectively. This allows TX1 to provide power to devices in its coverage area such as RX1 through RXn. Likewise, TX2 can provide power to devices in its coverage area such as RX1 through RXn.

Section 3

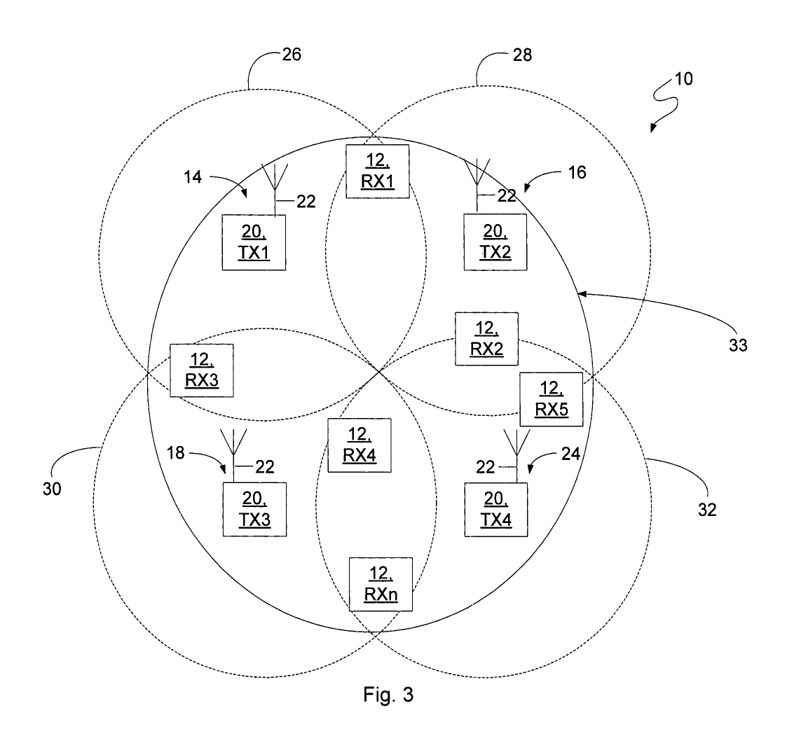

When the required coverage area 33 becomes too large for a single transmitter 20, multiple areas can merge, or overlap, creating a coverage area which is larger than any single coverage area from a single transmitter 20. As FIG. 3 shows, a first area 26 (Area 1), second area 28 (Area 2), third area 30 (Area 3) and a fourth area 32 (Area 4) have been arranged to provide an equivalent (or required) coverage area 33 greater than each individual area. It should be noted that in this arrangement each receiver 12 may be powered by multiple transmitters 20 due to area overlap. Area overlap occurs when two or more transmitters 20 are able to produce a field strength greater than the minimum value used to define the areas at a given point. As an example, a third receiver RX3 will receive power from both TX1 and a third transmitter TX3. This concept of merging areas can be expanded indefinitely to cover larger areas and different overall coverage arrangements (i.e. not a circle).

In a cellular telephone network, area overlap is detrimental to network performance. However, in transmission of RF power, area (cell) overlap is not detrimental to the network 10 performance. Cellular telephone networks have problems with overlap due to data collisions. The lack of data in RF power networks 10 allows cell overlap without this problem.

One problem that does arise is phase cancellation. This is caused when two Electromagnetic (EM) waves destructively interfere. This interference can cause dead spots. Dead spots are regions where the field strength is below the defined minimum value. Phase cancellation can cause dead spots within the defined area.

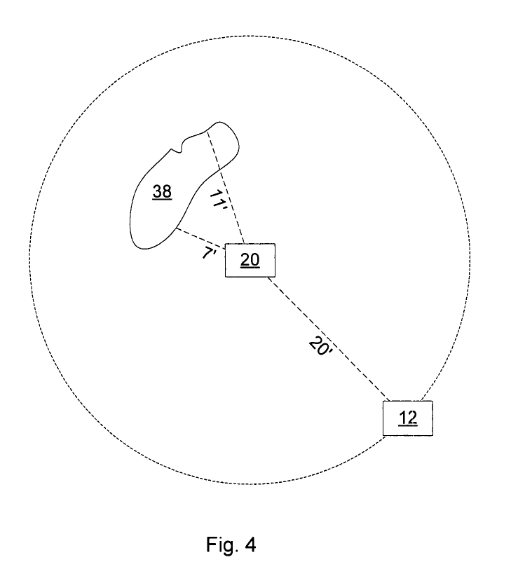

As an example, it can be estimated that a transmitter should be able to supply the required field strength to a receiver 12 at 20 feet. However, if the device containing the receiver 12 is tested at a radius of twenty feet from the transmitter, it may be found that the device will work at twenty feet, but there is a region between seven and eleven feet where the field strength is too low to operate the device. This area is termed a dead spot 38. This example is illustrated in FIG. 4.

There are several ways to combat this issue. One method, which is similar to a simple cellular network, is to have the transmitters of overlapping areas on different frequencies or channels. Another solution would be to have the transmitters of overlapping areas on different polarizations such as horizontal and vertical. Table 1 describes how the network 10 in FIG. 3 could be implemented to alleviate dead spots.

TABLE 1
Methods to alleviate dead spots for the network in FIG. 3

| Method | TX1 | TX2 | TX3 | TX4 |
|---|---|---|---|---|
| Non-over- | Frequency 1 | Frequency 2 | Frequency 2 | Frequency 1 |
| lapping | | | | |
| Frequencies | | | | |
| Non-over- | Horizontal | Vertical | Vertical | Horizontal |
| lapping | Polarization | Polarization | Polarization | Polarization |
| Polarization | | | | |

It may also be possible to alternate the polarization of the antenna 22 in a given coverage area (26, 28, 30, 32) such that the antenna 22 switches from horizontal to vertical in a repetitive fashion while not taking the polarization of an overlapping area. In order to accomplish this, a controller 36 must be introduced into the network 10 to oversee operation of the transmitters 20 and/or antennas 22. FIG. 5 shows one way this controller 36 could be implemented.

In this illustration, a master controller 36 is used to control all of the transmitters 20 and/or antennas 22 in the network 10. One implementation of the controller 36 would contain a central processing unit (CPU 55) or microcontroller unit (MCU) and memory 40, as shown in FIG. 20. This could be realized by using a microprocessor or simply a standard computer. The output of the controller 36 would be connected to each transmitter 20 and/or antenna 22, which would each contain a means for receiving the data and implementing the desired effect.

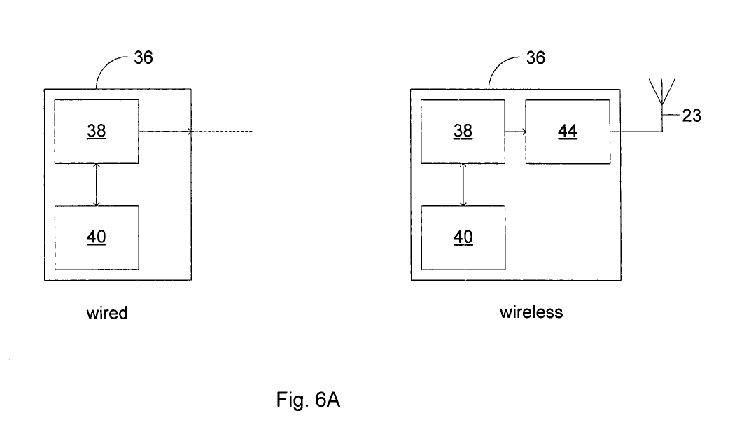

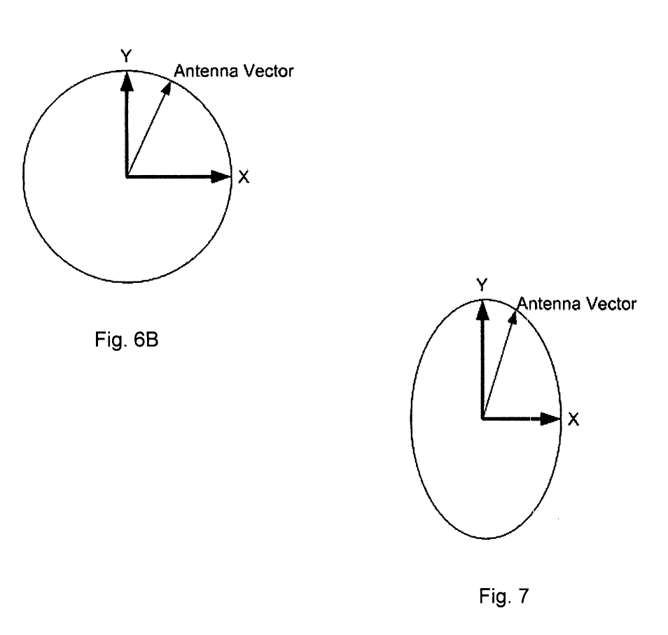

The communication link from the controller 36 may be implemented with a wired connection or a wireless link. When a wireless link is used, the controller 36 contains a transceiver 44 and a communication antenna 23, as shown in FIG. 6a. Each transmitter 20 and/or antenna 22 also contains a transceiver 44 and a communication antenna 23 to receive and transmit data.

Another way to implement the switching methods would be to integrate a controller 36 into each transmitter 20 unit or node. The controllers 36 could then communicate over a wired connection or by using a wireless link. These controller 36 units are shown in FIG. 6A. The controller 36 units would be integrated into the transmitter 20 and/or antenna 22 so the MCU or CPU 55 of the controller 36 would be the means that could receive and transmit data and also implement the desired effect by communicating with the transmitter 20 and/or antenna 22.

The added functionality given by the controller 36, either stand-alone or integrated into each transmitter 20 unit or node allows more elaborate methods to eliminate dead spots. By introducing the controller 36, each area has knowledge of the others' operation. For this reason, it is now possible to change the frequencies, polarizations, and/or shapes of the areas. It also becomes possible to turn each transmitter 20 on and off to form a pulsing network 10. Table 2 summarizes a few of the possible methods for eliminating dead spots using the network 10 in FIGS. 5 and 14.

TABLE 2
Methods to alleviate dead spots for the network in FIG. 5 and 14

| Method | Time Period | TX1 | TX2 | TX3 | TX4 |
|---|---|---|---|---|---|
| Non-overlapping | Time 1 | Frequency 1 | Frequency 2 | Frequency 2 | Frequency 1 |
| Frequencies | | | | | |
| | Time 2 | Frequency 2 | Frequency 1 | Frequency 1 | Frequency 2 |
| | Time 3 | Frequency 1 | Frequency 2 | Frequency 2 | Frequency 1 |
| | Etc. | | | | |
| Non-overlapping | Time 1 | Horizontal | Vertical | Vertical | Horizontal |
| Polarization | | Polarization | Polarization | Polarization | Polarization |
| | Time 2 | Vertical | Horizontal | Horizontal | Vertical |
| | | Polarization | Polarization | Polarization | Polarization |
| | Time 3 | Horizontal | Vertical | Vertical | Horizontal |
| | | Polarization | Polarization | Polarization | Polarization |
| | Etc. | | | | |
| Pulsing | Time 1 | ON | OFF | OFF | OFF |
| | Time 2 | OFF | ON | OFF | OFF |
| | Time 3 | OFF | OFF | ON | OFF |
| | Time 4 | OFF | OFF | OFF | ON |
| | Time 5 | ON | OFF | OFF | OFF |
| | Etc. | | | | |

As an example, the network 10 in FIG. 5 could be used to provide power to perimeter sensors 61 at a nuclear power plant to sense intruders. The four transmitters could be arranged to provide coverage over the entire fence line (required coverage area 33). The antennas 22 could be mounted on towers and produce directional or omni-directional patterns. Each overlapping area could be placed on a separate channel. The channel frequencies should be spaced far enough apart to avoid interference, although it may be beneficial to keep the channels close enough that the same antenna 22 design could be used with each transmitter 20. See FIG. 19 which shows such a security system 66.

A somewhat easy way to have more than one frequency is to fabricate each transmitter 20 using the exact same component values and design. Anyone skilled in the art knows that all components have tolerances, such as plus/minus 1 or 5 percent, based on slight manufacturing deviations and dependence on temperature changes, which are different from component to component. Therefore, the fabrication of more than one transmitter 20 with the same components and design will result in the transmitters 20 having slight variations in frequency being generated by the frequency generator and amplitude of the signal being outputted due to the manufacturing deviations and tolerances. These variations could result from the components being manufactured differently or they could be the result of one transmitter 20 being placed in a position where the transmitter 20 gets slightly warmer than the others. The slight differences between transmitters 20 with the same components and design will essentially place the transmitters 20 on slightly different frequencies or channels based on the tolerances of the components and design. The slight difference in frequency insures that at a given point in space, the signals from multiple transmitters 20 will constantly be drifting in and out of phase due to the slight difference in transmitted frequency meaning that at a certain time the two transmitted signals will destructively interfere while at a later time the two transmitted signals will constructively interfere. Thus, the average received RF power will be the same as if there was no interference between the two transmitted signals.

As can be seen from Table 2 and FIG. 5, all possible planes in the coverage area have RF power available by having the RF power transmitters 20 in the Power Network 10 use different polarizations for the RF power transmitting antenna 22, thus having power provided in all planes. Another way of designing a network 10 to provide power in all planes is to use circularly polarized antennas 22 for transmitting the RF power. A circularly polarized antenna 22 outputs a rotating signal, essentially distributing the output signal equally in both the horizontal and vertical planes and all planes between. The output of a circularly polarized antenna 22 can be described as a vector spinning around a circle with horizontal, or X, and vertical, or Y-axes that are equal in magnitude. There is only a finite amount of power being supplied to the antenna 22 by the RF power transmitter 20, so the power available in the X-direction and the power available in the Y-direction have to add to the total amount of power being supplied to the antenna 22 by the RF power transmitter 20. In circular polarization, the X- and Y-axes are equal in magnitude so each axis gets half of the power being supplied to the antenna 22 by the RF power transmitter 20, and the magnitudes add to the total power being supplied to the antenna 22 by the RF power transmitter 20. Because the X- and Y-axes are equal in magnitude, the antenna 22 vector will have the same magnitude no matter which way the antenna 22 vector points on the circle. These vectors can be seen in FIG. 6B.

There are 2 ways to implement such an antenna 22, right-handed polarization (RHP) and left-handed polarization (LHP). This refers to the direction in which the antenna 22 vector spins around the circle defined by the X- and Y-axes as above. In RHP, the antenna 22 vector spins in the clockwise rotation from the perspective of facing in the power propagation direction. In LHP, the antenna 22 vector spins in the counter-clockwise rotation from the perspective of facing in the power propagation direction. They are opposite to one another, so an antenna 22 set up for RHP can not receive signals from a LHP antenna 22, and vice versa.

A polarization that can be implemented in a similar fashion is elliptical polarization. Elliptical polarization can be described the same way as circular polarization was described above, as a vector spinning around an ellipse, except that the X- and Y-axes of the ellipse are not equal. As is obvious now, circular polarization is a special type of elliptical polarization, that where the axial ratio is equal to 1. The axial ratio is a numeric expression that is used as a specification for elliptically polarized antennas 22 and describes the ratio of the axes. The axial ratio is defined to be at least 1 with 1 being the axial ratio for a circularly polarized antenna 22. Because the axial ratio, by definition, cannot be less than 1, the result is taken as the axis with the larger magnitude divided by the magnitude of the other axis. This means that an axial ratio of 4 could have a magnitude of 4 units in the X-axis, but only a magnitude of 1 in the Y-axis. Or, an axial ratio of 4 could have a magnitude of 8 units in the Y-axis, but only a magnitude of 2 in the X-axis. Another parameter of the elliptically polarized antenna 22 is the tilt angle, which is the angle with respect to the X-axis of the maximum radius of the ellipse.

As with circularly polarized antennas 22, the antenna 22 vector can spin in either direction, making the antenna 22 RHP or LHP. Also, the magnitudes of each axis in an elliptically polarized antenna 22 add up to the total power being supplied to the antenna 22 by the RF power transmitter 20. However, the magnitudes of the axes are not the same, so as the vector spins around the ellipse, more power will be available in a certain plane than in a plane that is perpendicular to that plane. This is useful for a system 66 where it is known that the probability of a linearly polarized antenna 22 on an RF power-receiving device being in one plane is greater than the probability of that same antenna 22 being in a perpendicular plane. Most of the power is available when the antenna 22 is in its most probable position, but if it happens to not be in its most probable position, the device is still able to receive power. An elliptically polarized antenna 22 is shown in FIG. 7.

Therefore, the invention can be implemented using elliptically polarized antennas 22 for transmission of RF power where the axial ratio of the transmitting ellipse is set by the probability of the polarization of RF power receiving antenna 22. As an example, if the receiving antenna 22 has a 0.75 probability of being vertically polarized and a 0.25 probability of being horizontally polarized, 0.75 times the transmitted power will be placed in the vertical polarization vector while the remaining 0.25 times the transmitted power will be placed in the horizontal polarization vector. As can be seen, in general, the amount of power placed in the polarization vectors is directly set by the probability of the receiving antenna 22 being oriented in that plane or within some angle such as, but not limited to, 45 degrees from that plane.

As an example, when recharging a cellular phone using RF power harvesting, the probability that the cellular phone will be positioned so that the RF power harvesting antenna 22 is located vertically, such as when the cellular phone is in use or when the cellular phone is clipped to someone's belt, is higher than the probability that the cellular phone will be located in someone's pocket with the RF power harvesting antenna 22 located in the horizontal plane. Therefore, the amount of RF power transmitted in the vertical plane may be larger than the amount of RF power transmitted in the horizontal plane to increase the probability of supplying more power to the cellular phone.

The network 10 can be set up for all RF power transmitting antennas 22 to have the same polarization, RHP or LHP, to have different RF power transmitting antennas 22 that have different polarizations, or have RF power transmitting antennas 22 that can alternate between RHP and LHP similar to what was shown in Tables 1 and 2. It is also possible to mix the elliptically polarized RF power transmitting antennas 22 with the linearly polarized RF power transmitting antennas 22 to provide greater coverage in a certain plane or area. There are other forms of RF power transmitting antenna 22 polarizations that can be used for the RF power transmitting antennas 22 in RF power networks 10, and include, but are not limited to, dual polarization, dual-circular polarization, dual-elliptical polarization, or any other rotating or non-rotating polarizations. It is also possible for one RF power transmitter 20 in a Power Network 10 to have multiple RF power transmitting antennas 22, each with different polarizations.

It should be noted that the X-axis and Y-axis polarization components of a polarization such as, but not limited to, circular, elliptical, or dual could be implemented by using two antennas 22 with each antenna 22 transmitting an in or out of phase signal where the antenna 22 polarization vectors are orthogonal to each other.

Section 4

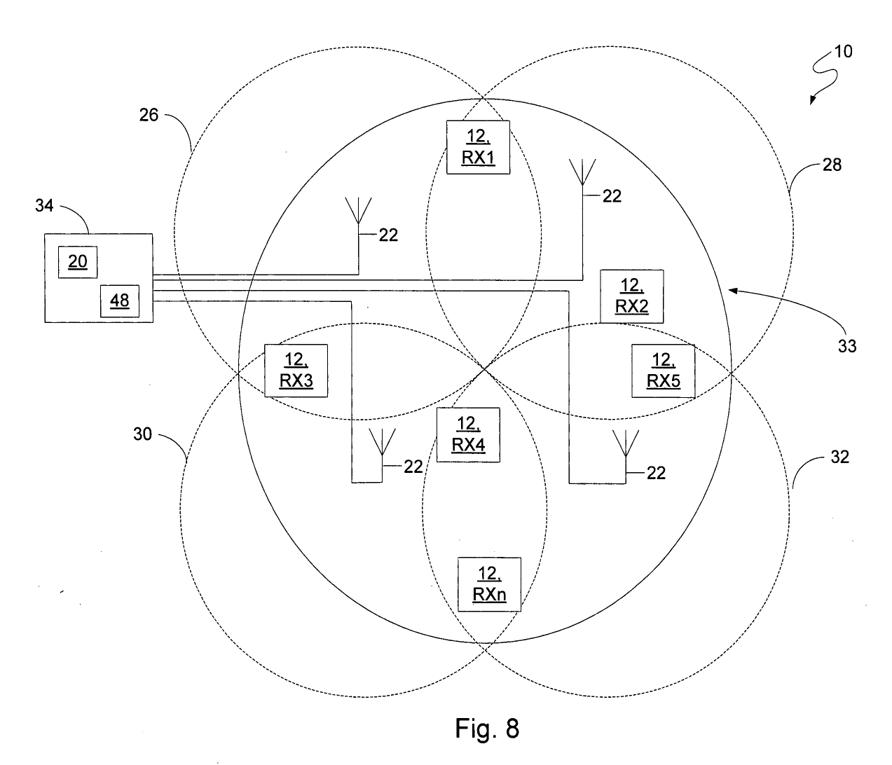

A simplification of the network 10 described in Section 3 is shown in FIG. 8. In this case, multiple transmitters 20 are replaced with a single transmitter 20 feeding multiple antennas 22. Coverage areas 26 and 28 may be non-overlapping, as shown, or may overlap. As illustrated in FIG. 2, the transmitter 20 may be included in a coverage area 26. The network 10 may be expanded to include additional coverage areas 30 and 32 as shown in FIG. 8.

The distribution of power to the antennas 22 can be accomplished in numerous ways; one of these includes a parallel feed system 66 as shown. The parallel feed system 66 could be implemented by integrating a device for routing power 48 (such as a power splitter, switch, etc.) into the transmitter 20. The outputs from, for example, the power splitter could then each be connected to an antenna 22 with an associated coverage area 26, 28, 30, 32.

This network 10 would again suffer from phase cancellation, which in turn causes dead spots. One way to alleviate this issue would be to use a method similar to the one proposed in provisional patent application 60/656,165 and corresponding non-provisional application Ser. No. 11/256,892, “Pulse Transmission Method,” incorporated by reference herein. The application describes the use of a pulsing transmitter 20 to help increase the efficiency of the receiver 12. This pulsing method can also be used with a network 10 to help eliminate dead spots.

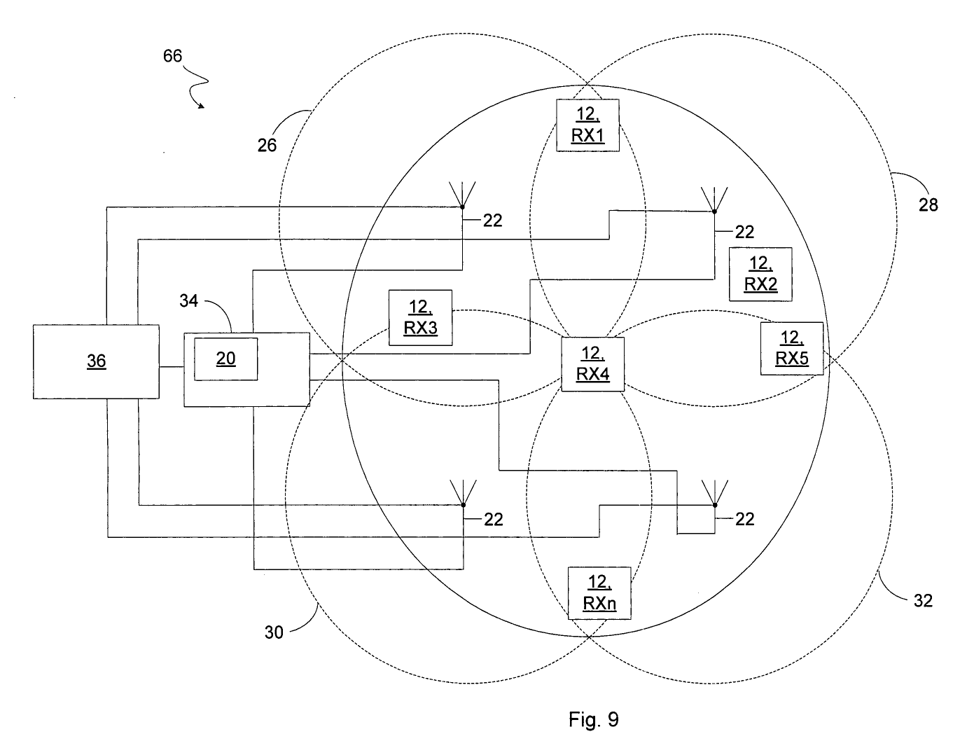

An example of a pulsing network 10 is shown in FIG. 9. The controller 36 controls the output of the transmitter 20 to pulse each antenna 22 either sequentially to insure that only one antenna 22 is active at a given time or in a pattern that will not activate antennas 22 of overlapping coverage areas 26, 28 at the same time, but may activate antennas 22 of non-overlapping coverage areas at the same time. Because only one antenna 22 in a given area is active at a given time no phase cancellation occurs due to area overlap.

There is still phase cancellation caused by reflections from objects within the coverage area. However, this method minimizes the effect of phase cancellation caused by reflects because the field is constantly changing its incident angle on a receiver 12. As an example, in FIG. 9, RX4 will receive a field from the upper left when Area 1 is active, from the upper right when Area 2 is active, from the lower left when Area 3 is active and finally from the lower right when Area 4 is active. This means that if RX4 is in a dead spot of Area 3 due to reflections, it will most likely not be in a dead spot of Area 4. This means the receiver 12 will capture power from the system 66 in this location.

Another issue that is alleviated by this system 66 is shadowing caused by multiple receivers. Shadowing occurs when a receiver is located behind another receiver with respect to the active transmitter 20 or antenna 22. The receiver closest to the transmitter 20 or antenna 22 will capture most of the power available at that angle with respect to the transmitter 20 or antenna 22. This means the receiver in the back will receive little or not power.

An example of this can be seen in FIG. 9. When Area 2 is active, RX2 will cast a shadow on RX5, and RX5 will receive little or no power. The use of an RF Power network 10 using pulsing eliminates this problem. RX5 will receive little or no power from the antenna 22 in Area 2. However, when Area 4 becomes active, RX5 will receive power.

It should be noted that the controller 36 in FIG. 9 could be used to change the frequency, polarization, or radiation pattern of the antennas 22 as described in Section 3. Also, if it is found advantageous, the controller 36 could be integrated into the transmitter 20. The controller 36 may be in communication with both the transmitter 20 and/or the antennas 22.

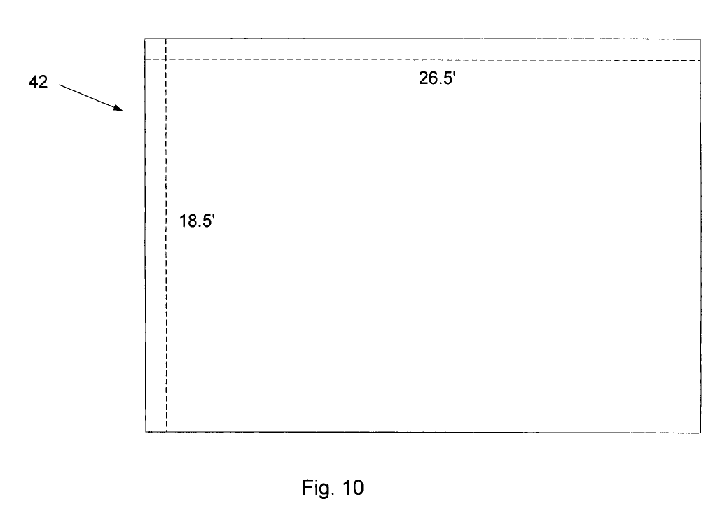

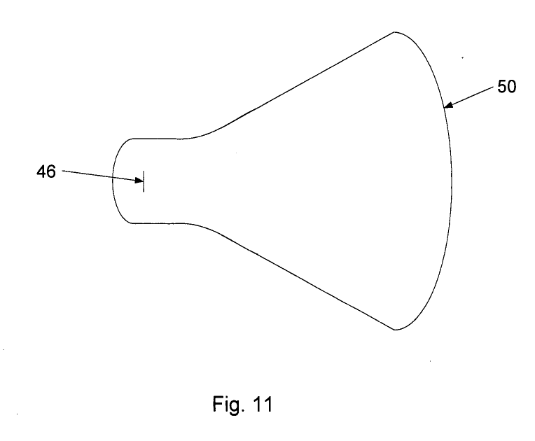

A test network similar to the network 10 shown in FIG. 9 was constructed to examine the benefits of an RF power network 10. First, the coverage area was defined as a 26.5 ft by 18.5 ft room 42. This is depicted in FIG. 10.

Next, various antennas 22 for the test network were examined to determine their individual coverage areas. In the implemented test network, a patch antenna 46 was used. For a patch antenna 46, FIG. 11 shows a measured coverage area 50 for a specific power level. Larger coverage areas 50 can be obtained by increasing the transmitter's 20 power level. With this increase in power, the coverage area 50 will keep its general shape, however, the dimensions will increase.

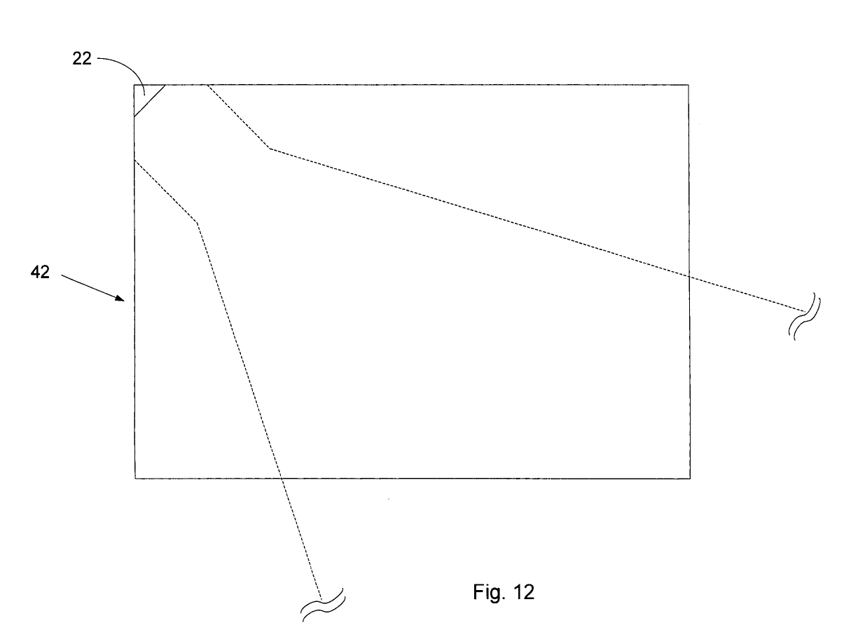

As can be seen in FIG. 12, only partial coverage is obtained using a single patch antenna 46 in one corner.

To provide better coverage, the system 66 was implemented with a patch antenna 46 in each corner to provide coverage over almost the entire room 42. FIG. 12 shows the coverage provided by a patch in each of the corners. The four patch antennas 46 were the same.

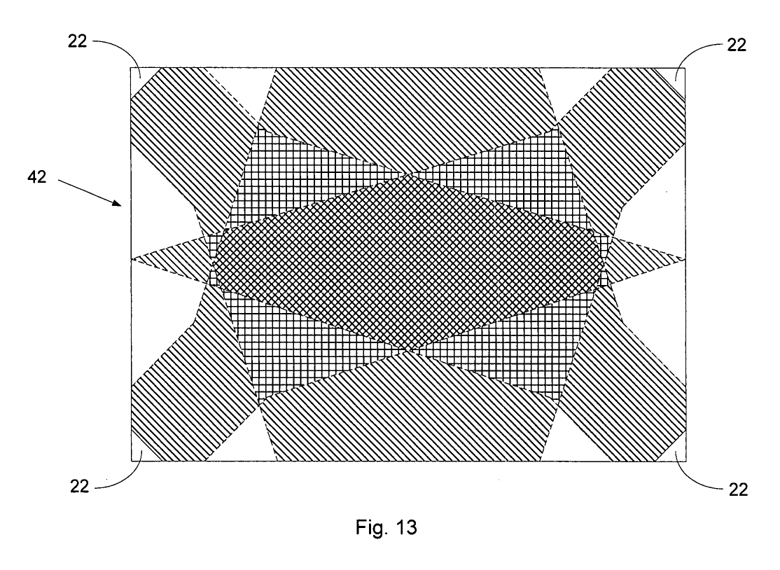

FIG. 13 shows the coverage achieved by the test network including a patch antenna 46 in each corner. Nearly full coverage was achieved. The diamond hatched section is where all four coverage areas overlap. The checkered hatched sections are where three coverage areas overlap, while the diagonal hatched sections are where two areas overlap. The white areas are where only one coverage area is present.

This network 10 was implemented with a single transmitter 20 as shown in FIG. 9. The transmitter 20 received its power from a room 42/building AC main, but could also be run by other power means (source), such as a battery pack.

The transmitter 20 had an integrated single-pole four-throw switch. The operation of the transmitter 20 was monitored by the controller 36, which was implemented with a microcontroller. The outputs of the transmitter's 20 switch were each connected to an individual antenna 22 using coaxial cable. The controller 36 was used to sequentially switch the transmitter's 20 outputs through the four perimeter antennas 22 to produce a pulsing waveform from each antenna 22. The implementation showed a decrease in shadowing effects and almost no dead spots due to the reasons previously described.

Section 5

When even larger coverage areas are required, the networks 10 described in Section 4 can be expanded to include more antennas 22, or the networks 10 shown in FIG. 8 or 9 can be duplicated/repeated. The duplication/replication of the network 10 of FIG. 9 is shown in FIG. 14. However, the frequency, polarization, and pulsing solutions previously described could be applied to this network 10 using the controllers 36 to alleviate the interference. As an example, if a pulsing method is employed, the networks 10 can be designed so that no overlapping areas are energized at the same time.

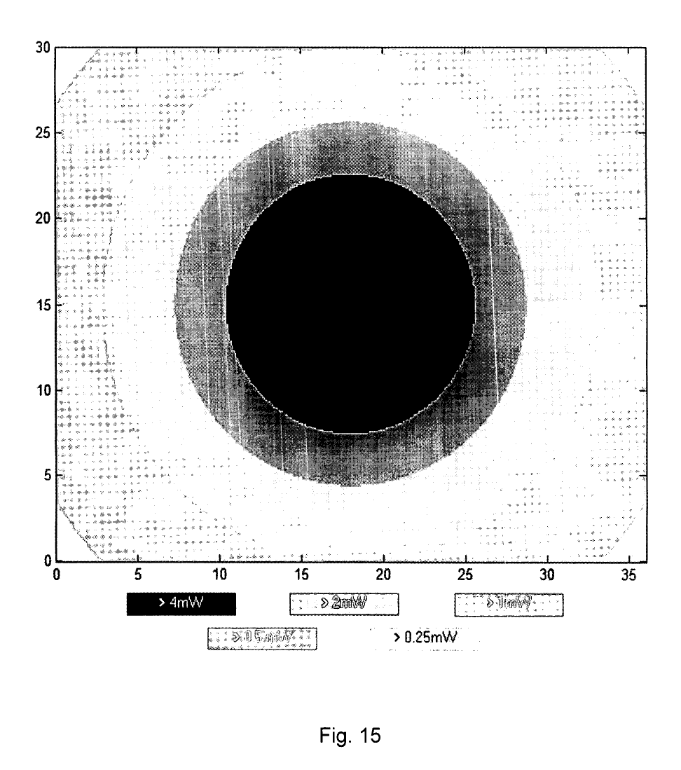

It should be noted that an RF power network 10 has distinct advantages over a single RF power transmitter 20. The RF power network 10 provides more uniform field strength (and power density) over the required coverage area due to the availability of power from multiple RF power transmitters 20 and when the network 10 is designed properly to avoid dead spots and/or phase cancellation, the multiple RF power transmitters' 20 power adds to give a higher power than a single RF power transmitter 20. As an example, a single RF power transmitter 20 located in the center of a room 42 will provide larger amounts of power near the center of the room 42 when compared to the corners of the room 42. The amount of power available will decrease by a factor of one over distance squared as the distance between the transmitter 20 and receiver 12 is increased. For an RF power network 10 with four RF power transmitters, one in each corner, there will be higher powers available near the corners of the rooms 42 compared to the center of the room 42 when examining a single corner RF power transmitter 20. However, when all four RF power transmitters 20 are examined, the power at the center of the room 42 will be greater than that provided by a single RF power transmitter 20 due the additional power provided by the other RF power transmitters 20. Therefore, as the receiver 12 moves away from a transmitter 20, the available power does not decrease by a factor of one over distance squared where the distance is between the receiver 12 and the transmitter 20. The available power may stay the same, may increase, or may decrease by a factor less than one over distance squared. As a specific example, take the room 42 requiring a coverage area of 36 by 30 feet shown in FIG. 15. A twenty-watt transmitter 20 is located at the center of the room 42 or at the coordinates of (18,15). As can be seen by examining the grayscale color code, RF power harvesting devices in the room 42 have the ability to harvest at least 0.5 milli-watts (mW) at nearly any location in the room 42 except for the minor areas in each corner.

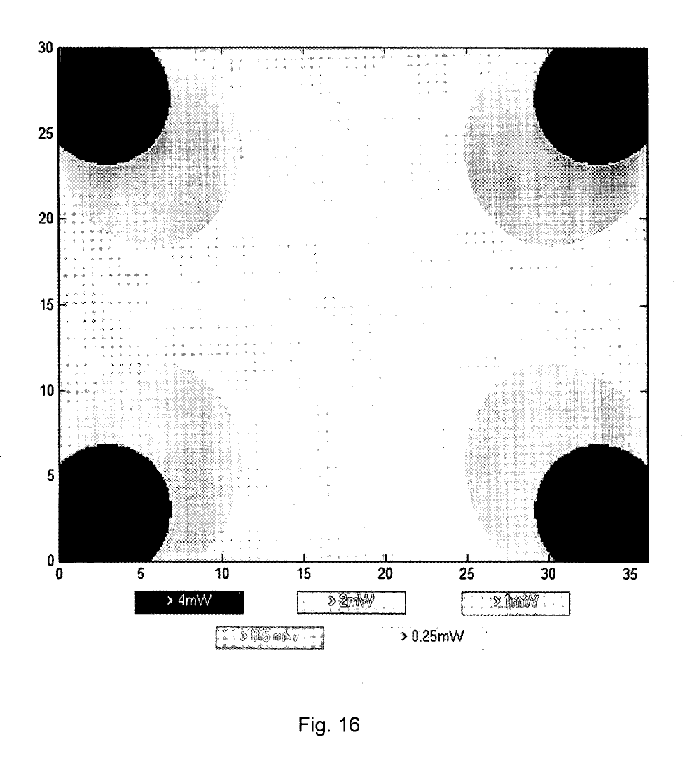

The coverage area given by the RF power transmitter 20 in FIG. 15 can also be implemented using an RF power network 10 as described herein. Consider the RF power network 10 shown in FIG. 16 where the single twenty-watt RF power transmitter 20 in FIG. 15 has been replaced with four five-watt transmitters 20 located in each corner, which cumulatively give twenty watts of transmitted RF power. As can be seen by FIG. 16, RF power harvesting devices in the room 42 now have the ability to harvest at least 1 mW anywhere in the room 42, which is twice the power available from the single twenty-watt RF power transmitter 20 in FIG. 15. Therefore, an RF power network 10 using multiple lower power transmitters 20 provides more power to devices in the coverage area with a more uniform coverage while maintaining the same cumulative transmitted power when compared to a single RF power transmitter 20.

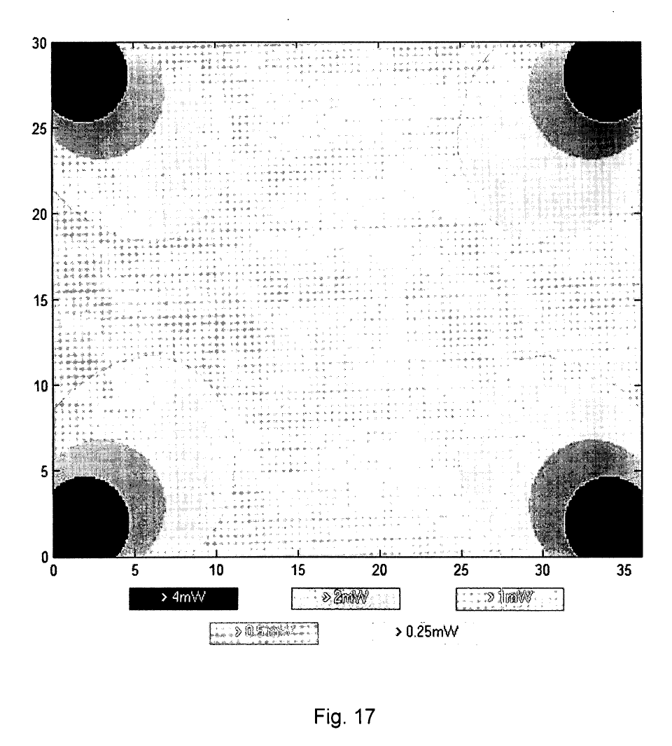

When comparing the RF power network 10 of FIG. 16 to the single RF power transmitter 20 in FIG. 15, it can be seen that the RF power network 10 of FIG. 16 gives twice as much power as a the single RF power transmitter 20 of FIG. 15. It therefore becomes possible to provide the same power coverage as a single RF power transmitter 20 with an RF power network 10 that transmits less total or cumulative power. FIG. 17 shows the same RF power network 10 as was shown in FIG. 16 except the power transmitted from each RF power transmitter 20 has been lowered from five watts per transmitter 20 to two and a half watts per transmitter 20. As FIG. 17 shows, RF power harvesting devices in the room 42 now have the ability to harvest at least 0.5 mW anywhere in the room 42, which is the same amount of power available from the single twenty-watt RF power transmitter 20 in FIG. 15. However, the total or cumulative power transmitted by the RF power network 10 in FIG. 17 is half of the power transmitted by the single RF power transmitter 20 shown in FIG. 15, or 10 watts, while providing the same power coverage. It should be noted that the RF power network 10 in the preceding example used an antenna 22 with directional gain to focus the power toward the center of the room 42 while the single RF power transmitter 20 used an omnidirectional antenna 22. The power comparison, however, is done by examining the power delivered to the antenna 22 and is not dependent on the gain of the antenna 22. The invention is not limited to directional antennas 22 and the results shown herein will produce similar results for all types of antennas.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

The invention claimed is:

1. A network for power transmission to a receiver which converts the power into current comprising:
a first node for transmitting power with circularly polarized waves in a first area; and
a second node for transmitting power with circularly polarized waves in a second area.

2. A network for power transmission to a receiver having an RF receiving antenna with a polarization which converts the power into current comprising:
a first node for transmitting power with elliptically polarized waves in the first area; and
a second node for transmitting power elliptically polarized waves in a second area.

3. A network as described in claim 2 wherein the polarized waves have polarization vectors with an axial ratio set by a probability of the polarization of the RF receiving antenna.

4. A method for power transmission to a receiver which converts the power into current comprising the steps of:
transmitting power with circularly polarized waves from a first node in a first area; and
transmitting power with circularly polarized waves from a second node in a second area.

5. A method for power transmission to a receiver having an RF receiving antenna with a polarization which converts the power into current comprising the steps of:
transmitting power with elliptically polarized waves from a first node in a first area; and
transmitting power with elliptically polarized waves from a second node in a second area.

6. A method as described in claim 5 wherein the polarized waves have polarization vectors with an axial ratio set by a probability of the polarization of the RF receiving antenna.

7. A network for power transmission to a receiver which converts the power into current comprising:
a first node for transmitting power with dual polarized waves in a first area; and
a second node for transmitting power with dual polarized waves in a second area.

8. A method for power transmission to a receiver which converts the power into current comprising the steps of:
transmitting power with dual polarized waves from a first node in a first area; and
transmitting power with dual polarized waves from a second node in a second area.

9. A network for power transmission to a receiver which converts the power into current comprising:
a first node having components for transmitting power at a first frequency in a first area; and
a second node having components for transmitting power at a second frequency in a second area, the second frequency is different than the first frequency due to tolerances in the components of the first and second nodes.

10. A method for power transmission to a receiver which converts the power into current comprising the steps of:
transmitting power with components at a first frequency of a first node in a first area; and
transmitting power with components at a second frequency of a second node in a second area, the second frequency is different than the first frequency due to tolerances in the components of the first and second nodes.

11. A network for power transmission to a receiver which converts the power into current comprising:
a first node for transmitting power on a first polarization in a first area; and
a second node for transmitting power on a second polarization in a second area.

12. A network for power transmission to a receiver which converts the power into current comprising:
a first node for transmitting power having first polarization vectors in a first area; and
a second node for transmitting power having second polarization vectors in a second area.

13. A network for power transmission to a receiver which converts a power into current comprising:
a plurality of transmitters which together use a first total transmitted power and yield a power coverage area equivalent to a single power transmitter power coverage area which uses a second total transmitted power, where the first total transmitted power is less than the second total transmitted power.

14. A method for power transmission to a receiver which converts the power into current comprising the steps of:
yielding a power coverage area with a plurality of transmitters which together use a first total transmitted power equivalent to a single power transmitter power coverage area which uses a second total transmitted power, where the first total transmitted power is less than the second total transmitted power; and
receiving power by the receiver in the power coverage area from at least one of the plurality of transmitters.

15. A system for power transmission, comprising:
a receiver including a receiver antenna; and
an RF power transmitter including a transmitter antenna,
wherein the RF power transmitter transmits RF power,
the RF power includes multiple polarization components, and
the receiver converts the RF power to DC.

16. The system according to claim 15, wherein the RF power does not include data.

17. The system according to claim 15, wherein the RF power transmitter pulses the transmission of the RF power.

18. The system according to claim 15, wherein the transmitter antenna includes more than one antenna.

19. The system according to claim 15, wherein the receiver is included in a sensor.

20. The system according to claim 15, further comprising more than one receiver.

21. The system according to claim 15, wherein the RF power is used to charge at least one power storage component.

22. The system according to claim 15, wherein the RF power is used to directly power a device.

23. A system as described in claim 15 including a controller connected to the transmitter to switch the polarization of the antenna.

24. A system as described in claim 23 wherein the controller includes a CPU or MCU and a memory.

25. A system as described in claim 15 including a plurality of controllers and a plurality of transmitters with one of the plurality of controllers associated with one of the plurality of transmitters, and the controllers communicate with each other to coordinate the polarization of each transmitter at a given time.

26. A system as described in claim 25 wherein each transmitter has an associated area in which it transmits and the controller controls the polarization, frequency or shape of the area in which its associated transmitter transmits.

27. A system as described in claim 26 wherein the controllers are used to form a pulsing network regarding transmission of the RF power.

28. A system as described in claim 15 including a plurality of transmitters, each transmitter transmitting at a different frequency, each transmitter having the exact same components, values and design.

29. A security system to sense intruders comprising:
a plurality of sensors to sense the intruders disposed about a parameter, each sensor has an RF wireless receiver to receive RF wireless energy and convert it into current to power the sensor; and
a plurality of transmitters to provide wireless RF energy to the receivers.

30. A method for power transmission comprising the steps of:
transmitting RF power wirelessly having multiple polarization components with an RF power transmitter having a transmitter antenna;
receiving the wireless RF power at a receiver having a receiver antenna; and
converting the RF power to DC by the receiver.
